(19) United States
(12) Patent Application Publication
(10) Pub. No.: US 2011/0132150 A1
(43) Pub. Date: Jun. 9, 2011

(54) TOOLS FOR REMOVING A CAP FROM A FILTER HOUSING, AND ASSOCIATED METHOD

(76) Inventor: Kenneth J. HIXSON, Dennison, OH (US)

(21) Appl. No.: 12/634,068

(22) Filed: Dec. 9, 2009

(51) Int. Cl. B25B 13/02; B23P 19/00

(52) U.S. Cl. 81/119; 29/426.5

(57) ABSTRACT

Tools for removing a cap from a filter housing, and an associated method are presented. A first tool is adapted for secure engagement with a cap of a filter assembly, while a second tool is adapted for engagement with the cylindrical body thereof. The first tool includes at least a pair of pin assemblies extending perpendicularly from the head of the tool. The second tool includes an annular plate characterized by circumferentially spaced notches adapted for receiving a cylindrical housing and particularly receiving and engaging ribs extending from such cylindrical housing. The application of opposite torques by the application of force to associated handles achieves the separation of the cap from the housing.

### TECHNICAL FIELD

The invention herein resides in the art of hand tools and their methods of use. More particularly, the invention relates to a set of tools adapted for use in separating a cap from a filter housing. More specifically, the invention relates to a set of tools and associated method for removing a threaded cap from a cylindrical housing of a water filter.

### BACKGROUND ART

The use of filters for separating contaminates and other undesired materials from fluids is commonly known. Such fluids may include fuels, lubricants, or in the case of the instant invention, drinking water. The filter itself generally comprises a filter media such as a wound or spun fiber or fabric, received within a housing. This filter cartridge serves to trap or restrain the passage of contaminants, while allowing the drinking water or other fluid to pass therethrough. As time passes, the filter media itself beings to clog or “blind” such that its filtering capacity and efficiency is diminished to the point that the cartridge needs replacing. At that point in time, it is necessary to make access to the interior of the filter housing, such that the cartridge can be removed and replaced.

It has been found that, particularly in association with drinking water, contaminants such as iron, calcium, and other materials may build up on the threads allowing interconnection between the filter housing and its cap, to the extent that separation of the cap from the housing is an extremely difficult proposition. When such filters are used for drinking water, the cap of the filter assembly itself is typically not restrained, but is a free standing unit connected to flexible hoses. Accordingly, it is necessary to restrain the cap of the assembly, to which the inlet and outlet hoses are attached, while the remainder of the filter is separated therefrom. However, with contamination at the threads, it is often an impossibility to physically apply sufficient force or torque to remove the filter housing body from the cap. This is in contradistinction to fixed filters, in which the cap is physically restrained by means of interconnection with rigid pipes or the like.

There is a need in the art for a set of tools and associated methods that facilitates the removal of the cap from the housing to allow removal and replacement of the filter cartridge.

### DISCLOSURE OF INVENTION

In light of the foregoing, it is an aspect of the invention to provide tools for removing a cap from a filter housing, and an associated method, by which a freestanding and unrestrained filter assembly may have the cap and housing separated for removal and replacement of the filter cartridge.

Another aspect of the invention is the provision of tools for removing a cap from a filter housing and associated method, in which a first tool is adapted for securing engagement with the cap, and a second tool for securing engagement with the filter housing.

Still a further aspect of the invention is the provision of tools for removing a cap from a filter housing, and associated method, allowing for the application of oppositely directed torque to the cap and the filter housing, to achieve separation therebetween.

Yet another aspect of the invention is the provision of tools for removing a cap from a filter housing, and associated method by which the cap can be restrained while the filter housing is rotatably unscrewed therefrom.

Still a further aspect of the invention is the provision of tools for removing a cap from a filter housing, and associated method in which a first tool is provided with pins for engagement with partial depth bores within the cap, and a second tool is provided with an annular ring having notches about an internal surface thereof, the notches being adapted for inter-engagement with ribs on the filter housing.

Yet a further aspect of the invention is the provision of tools for removing a cap from a filter housing, and associated method that may be easily and effectively achieved with state of the art apparatus and techniques.

### SUMMARY OF THE INVENTION

The foregoing and other aspects of the invention that will become apparent as the detailed description proceeds are achieved by a set of tools for removing a cap from a filter housing to which it is threadedly secured, comprising: a retaining tool having a first head secured to an end of a first handle, said head having at least a pair of pins extending therefrom, said pins adapted for securing engagement with bores in a filter cap; and a rotating tool having a second head secured to an end of second handle, said head having at least a notch formed therein, said notch adapted for receiving a rib extending from the filter housing.

Yet other aspects of the invention which will become apparent herein are achieved by a method for separating a cap from a filter housing, comprising: engaging pins of a first tool with bores of the cap; engaging notches of a second tool with ribs of the filter housing; and imparting oppositely directed torque to said filter housing by said second tool.

### DESCRIPTION OF THE DRAWINGS

For a complete understanding of the aspects and techniques of the invention, reference should be made to the following detailed description and accompanying drawings wherein:

FIG. 1 is a bottom perspective view of a first tool of the invention;

FIG. 1A is a side elevational view of the tool shown in FIG. 1;

FIG. 2 is a top perspective view of a second tool of the invention;

FIG. 2A is a side elevational view of the tool shown in FIG. 2; and

FIG. 3 is a perspective view illustrating how the tools shown in FIGS. 1 and 2 may be used to remove a filter housing from a cap and, alternatively, to secure such filter housing to the cap.

### BEST MODE FOR CARRYING OUT THE INVENTION

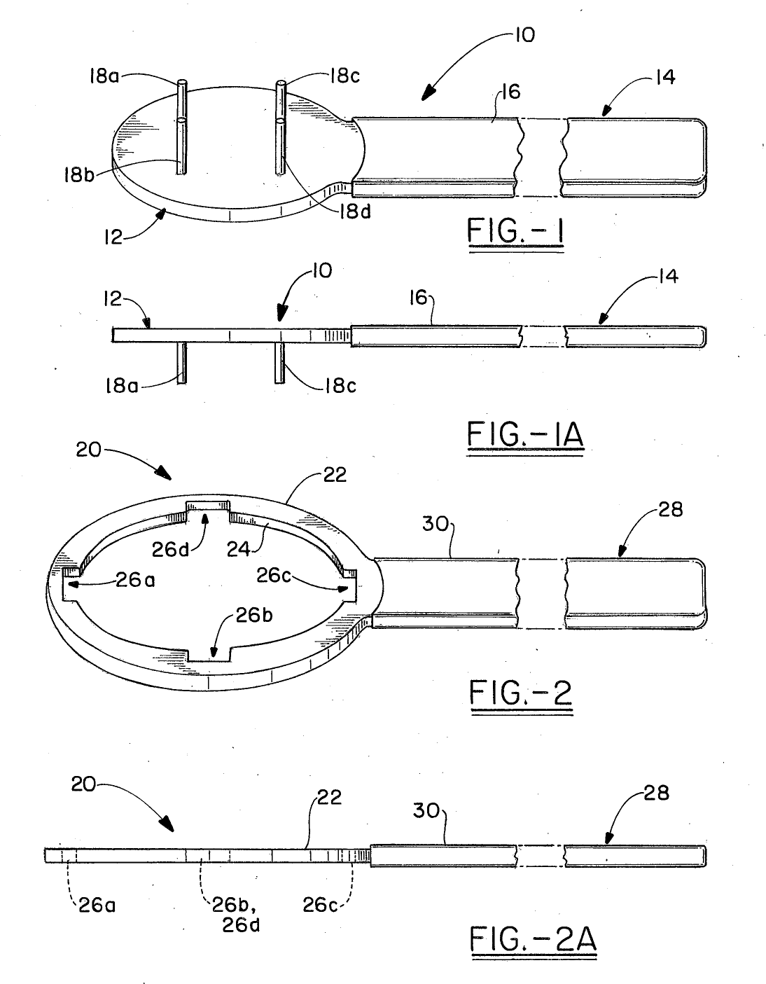

Referring now to the drawings and more particularly FIGS. 1 and 1A, it can be seen that a retaining tool made in accordance with the invention is designated generally by the numeral 10. The retaining tool 10 includes a head 12, which may be of any suitable geometric configuration, but is preferably disk shaped. The head 12 is interconnected with a handle 14 extending radially therefrom. Accordingly to a preferred embodiment of the invention, the handle 14 may be provided with a sleeve 16 to accommodate gripping and use by an individual. The sleeve 16 may be formed by dipping, shrink wrapping, or friction fitting the sleeve, as desired.

The head 12 is characterized by a plurality of pins 18a, 18b, 18c, 18d, extending orthogonally therefrom or perpendicular thereto. It will be appreciated by those skilled in the art that at least a pair of pins 18a-18d is desired, four such pins being preferred. As will become apparent herein, the pins 18a-18d are positioned and configured for receipt by partial depth bores within the cap of a filter assembly with which the tool 10 is employed. The pins 18a-18d are preferably of a length of approximately 0.75-1.5 inches, and most preferably 1 inch.

With reference now to FIGS. 2 and 2A, it can be seen that the rotating tool of the invention is designated generally by the numeral 20. The rotating tool 20 includes an annular ring 22 having an inner circumferential surface 24 defining an annulus of a diameter sufficient to accommodate the cylindrical housing of the filter assembly. Positioned about the inner circumferential surface 24 are a plurality of notches 26a, 26b, 26c, 26d, uniformly spaced. Of course, the size and positioning of the notches 26a-26d is dependent upon the associated filter housing.

Extending from the annular ring 22 is a handle 28, again provided with a sleeve of elastomeric or other material to accommodate gripping and hand engagement of an operator. The sleeve 30 may be provided by dipping, shrink wrapping, or friction fitting.

It will be appreciated that the handles 14, 28 may be of any desired size and shape, but it has been found that a desired torque may be achieved by the use of handles having a length of between 6 and 14 inches, and preferably 10 inches.

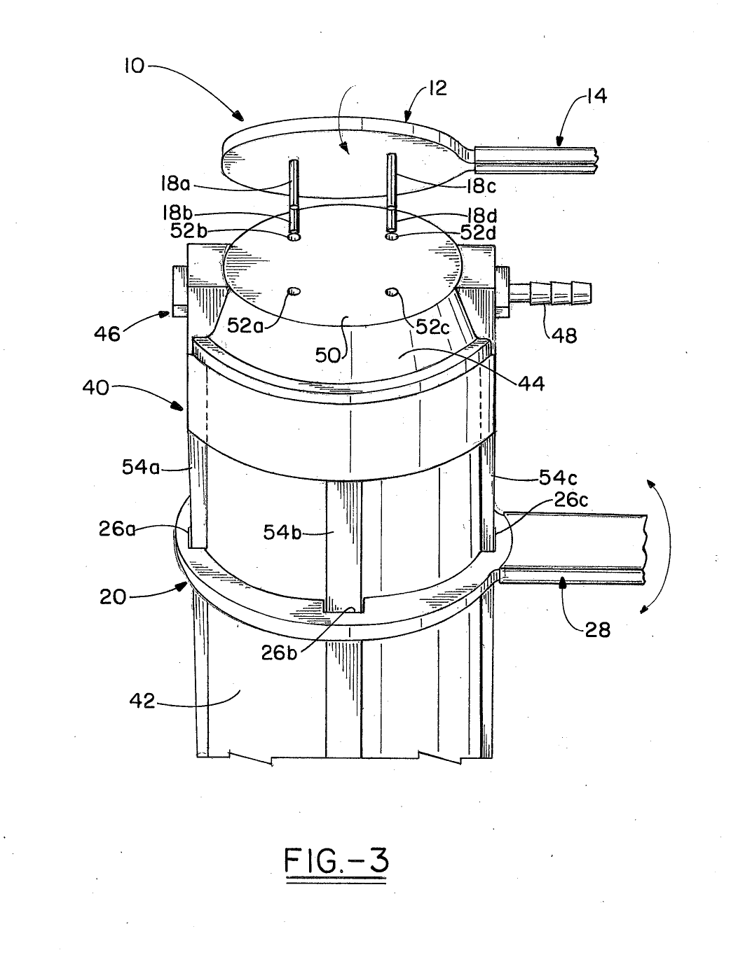

With reference now to FIG. 3, an appreciation can be obtained as to the method of use of the tools 10, 20 for separating a cap from a filter assembly. As shown in FIG. 3, the filter assembly 40 comprises a cylindrical housing 42 adapted for maintaining a filter medium in the form of an appropriate cartridge, the filter medium being formed from appropriate fibers or fabric. A cap 44 is in threaded engagement with the cylindrical housing 42 and is provided with an inlet connector 46 and an outlet connector 48, in standard fashion. Fluid, such as drinking water, enters through the inlet connector 46, passes into the cylindrical housing 42, through the filter cartridge, and out through the outlet connector 48.

As shown, the cap 40 is characterized by a top plate 50 having a plurality of partial depth bores extending thereinto. According to a preferred embodiment of the invention, there are four such bores, 52a, 52b, 52c, 52d. While four partial depth bores are shown, at least two are desired. The bores 52 are of such size, orientation and positioning to receive the corresponding pins 18 of the tool 10, as illustrated. For purposes of illustration, the tool 10 is shown disengaged from the cap 44, it being appreciated that when the tool 10 is rotated downwardly in the direction of the associated arrow, the pins 18a-18d are positioned to be fully received by corresponding partial depth bores 52a-52d. With the tool 10 so engaged with the cap 44, a user may, by gripping the handle 14, restrain or securedly hold the cap 44.

As further shown in FIG. 3, the cylindrical housing 42 is characterized by a plurality of ribs 54a, 54b, 54c, 54d (54d being obscured in the drawing), which ribs are sized and circumferentially spaced for receiving associated notches 26a-26d of the tool 28 when the annulus of the tool is moved upwardly over the cylindrical housing 42. With the rib 54 being engaged by associated notches 26, a user may secure the handle 28 and, by applying a torque thereto, threadedly disengage the cylindrical housing 42 from the cap 44 while restraining the tool 10.

Typically, the tools 10, 20 are only used for “breaking” the cylindrical housing 42 from the cap 44, the remainder of the unthreading being readily achieved by hand engagement of the housing 42 and cap 44. Similarly, reengagement of the housing 42 with the cap 44, after replacement of the filter cartridge, can typically be made by hand. However, if a tighter fit is necessary or desired, use of the tools 10, 20 may be employed. In either the engaging or disengaging modes of operation, opposite torques are applied to the handles 14, 28 of the tools 10, 20.

It will be appreciated by those skilled in the art that the tools 10, 20 may be made of any suitable material, such a high impact molded plastic, or machined or cast metal, or the like. It will further be appreciated that the pins of the tool 10 be of sufficient size and orientation to engage the bores of the cap 44, and that the notches of the tool 20 be of sufficient configuration and spacing to engage the ribs 54 of the cylindrical housing 42.

Thus it can be seen that the various aspects of the invention have been achieved by the structure and method presented and described above. While in accordance with the patent statutes only the best mode and preferred embodiment of the invention has been presented and described in detail, the invention is not limited thereto or thereby. Accordingly, for an appreciation of the true scope and breadth of the invention reference should be made to the following claims.

What is claimed is:

1. A set of tools for removing a cap from a filter housing to which it is threadedly secured, comprising:
a retaining tool having a first head secured to an end of a first handle, said head having at least a pair of pins extending therefrom, said pins adapted for securing engagement with bores in a filter cap; and
a rotating tool having a second head secured to an end of second handle, said head having at least a notch formed therein, said notch adapted for receiving a rib extending from the filter housing.

2. The set of tools according to claim 1, wherein said first head is flat, and said pins extend perpendicularly from said flat head.

3. The set of tools according to claim 2, wherein said second head is annular, said notch being formed in an inside circumferential surface of said annular head.

4. The set of tools according to claim 3, wherein said first head comprises four uniformly spaced pins extending perpendicularly therefrom.

5. The set of tools according to claim 4, wherein said second head is characterized by four uniformly spaced notches in said inside circumferential surface.

6. The set of tools according to claim 5, wherein said first and second handles are of a length of between 6 inches and 14 inches.

7. The set of tools according to claim 6, wherein said first and second handles are each covered by an elastomeric sleeve.

8. A method for separating a cap from a filter housing, comprising:
engaging pins of a first tool with bores of the cap;
engaging notches of a second tool with ribs of the filter housing; and
imparting oppositely direct torque to said filter housing by said second tool.

9. The method as recited in claim 8, wherein said torque for each of said first and second tools is effected by the application of force to respective handles of said tools.

10. The method as recited in claim 9, wherein said second tool is annular and wherein the step of engaging notches comprises slipping an annulus of said second tool over said filter housing and engaging said notches and ribs.
